(19) United States
(12) Patent Application Publication
(10) Pub. No.: US 2025/0005382 A1
(43) Pub. Date: Jan. 2, 2025

(54) AUTOMATED IDENTIFICATION AND UTILIZATION OF SEMANTIC INFORMATION FOR CONTENT ITEMS

(71) Applicant: Yahoo Assets LLC, New York, NY (US)

(72) Inventors: Sanika Shirwadkar, Milpitas, CA (US); Kostas Tsioutsiouliklis, Saratoga, CA (US)

(21) Appl. No.: 18/217,573

(22) Filed: Jul. 2, 2023

(51) Int. Cl. G06N 5/022

(52) U.S. Cl. CPC G06N 5/022

(57) ABSTRACT

One or more systems and/or methods for identifying and utilizing semantic information for content items are provided. Data is collected from data sources that provide information about content items. Authority scores are assigned to the data sources based upon authoritativeness of the data sources. The data from the data sources is processed to create candidate collections of semantic information. The authority scores are utilized to select semantic information for the content item from the candidate collections. A semantic-based action is performed using the semantic information.

### BACKGROUND

Content provider services provide various types of content items that can be accessed by users through computing devices. In an example, a user can utilize a mobile device to access a mobile app store through which the user can browse app store pages of mobile apps that the user can download to the mobile device. In another example, the user can access a multimedia content provider service in order to access and view multimedia content items such as videos, music, movies, videogames, etc. Also, the user can access a shopping service through which the user can view products that are available for purchase.

### SUMMARY

In accordance with the present disclosure, one or more computing devices and/or methods for identifying and utilizing semantic information for content items are provided. As part of identifying semantic information for content items such as mobile apps (applications), music, movies, videos, products (e.g., consumer products and services), videogames, etc., various data sources that provide information about the content items are identified. The data sources may comprise a mobile app data feed of mobile apps capable of executing on user devices, app store pages of an app store (e.g., an app storage page where a user can read a description about an application, read user reviews for the application, download the application, etc.), content item pages of a content provider services for content items available through the content service provider (e.g., content item pages of movies, music, products, videos, etc.), review websites with reviews about content items, user reviews for content items, search results for search queries related to content items, etc. In this way, data is collected from the various data sources.

Authority scores are assigned to the data sources based upon authoritativeness of the data sources. The authoritativeness may be based upon a source type (e.g., a user review that could be noisy and sparse vs a profession review or a description provided by an app developer that may be more comprehensive), a domain quality (e.g., how trusted is a search result or review website), information comprehensiveness (e.g., one user review may be sparse, while another user review may be comprehensive and detailed). The data may be processed to create candidate collections of semantic information corresponding to categories, entities, and/or terms such as key phrases or keywords. In some embodiments, a candidate collection may correspond to a source-specific bag of semantic information candidates of categories, entities, and/or terms from a particular data source for a particular content item, which may be identified using a text processor, machine learning models, a deep learning model, N-grams, a text analysis platform, etc. Additional processing may be performed for selecting semantic information for the content item, such as removing/filtering blacklisted entries (e.g., offensive or sensitive information), ranking candidate collections (bags) based upon relevance, frequency, and uniqueness, and creating weighted combinations of categories, entities, and/or terms. A final candidate selector may take the filtered and ranked candidate collections as input, and may utilize the authority scores and the weighted combinations of categories, entities, and relevant terms to select relevant semantic information for the content item.

Various semantic-based actions may be performed using the relevant semantic information. In some embodiments of performing a semantic-based action, a content item such as an application is tagged with the semantic information so that the semantic information is available for users to access. In some embodiments of performing a semantic-based action, operation of an application is modified based upon the semantic information in order to provide a user with a personalized experience while interacting with the application. In some embodiments of performing a semantic-based action, content is selected from available content based upon the content corresponding to the semantic information, and the content is provided or recommended to a user. In some embodiments of performing a semantic-based action, content is generated based upon the semantic information and interests of a user, and the content is provided or recommended to a user. In some embodiments of performing a semantic-based action, a model is trained using the semantic information for identifying interests of users and/or for identify content items that may be relevant to users, and thus the model is used to select and provide or recommend content to a user that may be interested in the content (e.g., a user interacting with various health apps may be interested in a health article or a food nutrition delivery service).

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method for identifying and utilizing semantic information for content items.

FIG. 5 is a component block diagram illustrating an example system for identifying and utilizing semantic information for content items.

FIG. 6A is a component block diagram illustrating an example system for identifying and utilizing semantic information for mobile apps.

FIG. 6B is a component block diagram illustrating an example system for identifying and utilizing semantic information for multimedia content.

FIG. 6C is a component block diagram illustrating an example system for identifying and utilizing semantic information for products.

FIG. 7 is an illustration of a scenario featuring an example non-transitory machine readable medium in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

### 1. Computing Scenario

The following provides a discussion of some types of computing scenarios in which the disclosed subject matter may be utilized and/or implemented.

### 1.1. Networking

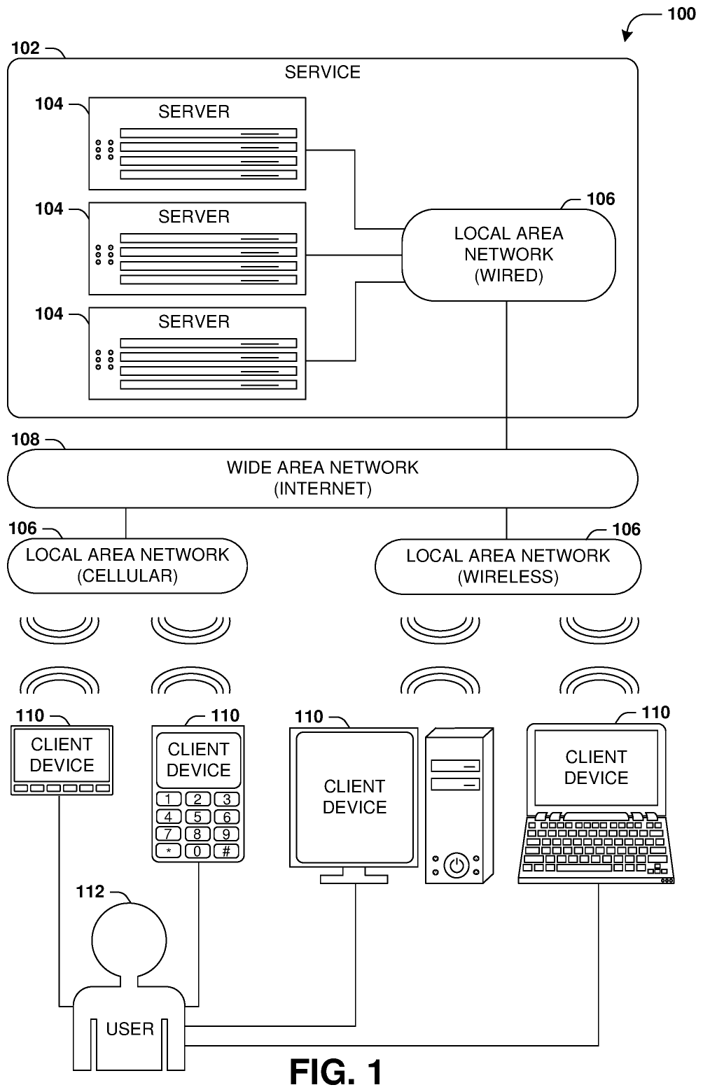

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ different architectures, may be compliant or compatible with differing protocols and/or may interoperate within the local area network 106. Additionally, a variety of local area networks 106 may be interconnected; e.g., a router may provide a link between otherwise separate and independent local area networks 106.

In scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

### 1.2. Server Configuration

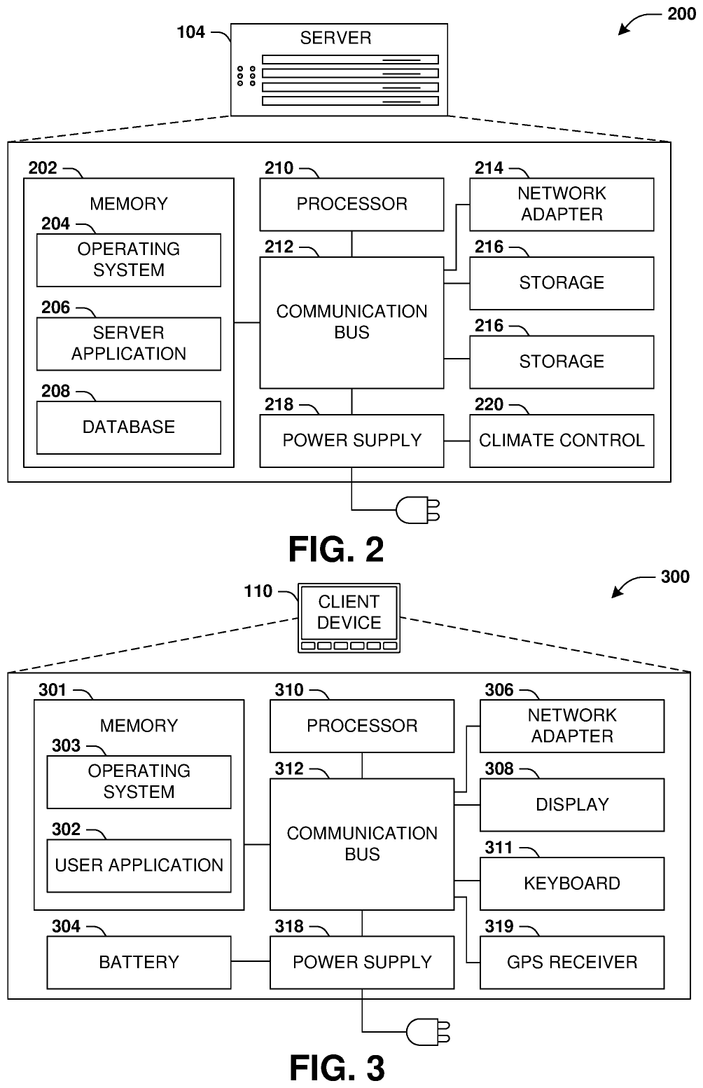

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic architecture diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

### 1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

### 2. Presented Techniques

One or more systems and/or techniques for identifying and utilizing semantic information for content items are provided. Content provider services such as mobile app stores, music streaming services, movie streaming services, videogame purchasing services, shopping websites, and/or other types of content provider services provide users with access to content items. Many of these content provider services provide a large user base with access to millions of content items (e.g., smartphone owners with access to millions of mobile apps that can be downloaded to smartphones), and thousands of new content items may be added monthly (e.g., thousands of new mobile apps may be released through a mobile app store over a month period). It is impracticable, if not impossible, to manually identify and/or tag the content items with semantic information relevant to the content items because of the shear amount of ever increasing content items that become available on a daily basis. This semantic information would provide valuable insight into what types of content items may be interesting to certain users, which could be used for content creation, content recommendation, personalization, and/or other technical purposes such as training machine learning models to more accurately predict user interest used to create and provide recommendations and personalized content to users.

In order to overcome these technical challenges, the disclosed techniques relate to computer implemented processes that generate relevant semantic information for content items in an automated manner, which can be used to perform a wide variety of semantic-based actions that can be executed in real-time or near real-time as new content items become available. The semantic-based actions may include the tagging of a content item with relevant semantic information so that the semantic information is available for users to access. The semantic-based actions may include modifying the operation of an application based upon relevant semantic information in order to provide a user with a personalized experience while interacting with the application or other similar applications. The semantic-based actions may include selecting a content item from available content items based upon the content item corresponding to the semantic information, and providing or recommending the content item to a user. The semantic-based actions may include generating content based upon the semantic information and interests of a user, and providing or recommending the content to a user. The semantic-based actions may include utilizing the semantic information to train a model for identifying content items that may be relevant and/or interesting to users, and thus the model can be used to select and provide or recommend content to a user that may be interested in the content.

The disclosed techniques for automated generation of semantic information and execution of semantic-based actions solve the aforementioned technical problems related to how it is impractical, if not impossible, to scale out a manual semantic labeling approach for a large number of content items that can be ever increasing on a daily basis. Every day, a significant number of new content items (e.g., thousands of new mobile apps being released through an app store on a daily basis) may be added to a content provider service. A one-time processing of content items that are currently available through the content provider service at a particular point in time is inadequate because new content items are being continually added to the content provider service. Accordingly, the disclosed techniques are configured to automatically identify, process, and identify semantic information for newly added content items at regular intervals to ensure that the latest content items are tagged with relevant semantic information.

Also, the techniques provided herein are capable of utilizing data from multiple disparate data sources of semantic information (alone and also in combination), which broadens the scope of data availability and improves precision, recall, and coverage when training machine learning models using the semantic information because a single source of information would result in reduced precision, recall, and coverage such as if the single data source of information is noisy and/or has spare information (e.g., unhelpful user reviews). In this way, each data source is processed separately and in combination, along with the use of domain-based authority scores to ensure the quality of the semantic information being output.

The semantic information is used for performing semantic-based actions whose execution will produce more precise and accurate results. For example, a machine learning model may be trained to more accurately identify content that is interesting to a user and/or to identify certain interests or attributes of the user (e.g., gender and age prediction). Additionally, the semantic information may be used to identify and provide content that is more interesting to the user. Furthermore, the semantic information may be used to generate and provide real-time recommendations and content to the user such as in response to new content items become available for real-time processing. The semantic information may be used to more accurately identify applications or content items that are similar to other applications or content items that were processed so that similar applications or content items can be recommended to users. The semantic information may be used to derive more accurate information about a user such as age, gender, location, interests, etc. (e.g., the semantic information is used as features for age, gender, and other prediction models). For example, a user interacting with a sketching app and/or other art based applications may be identified as having an interest in drawing. A user interacting with a university application may be identified as being college age. A user watching children shows may be identified as being a child. In this way, semantic information may be obtained and semantic-based actions may be executed in an automated and/or real-time manner for improving the operation of technical processes and machine learning models.

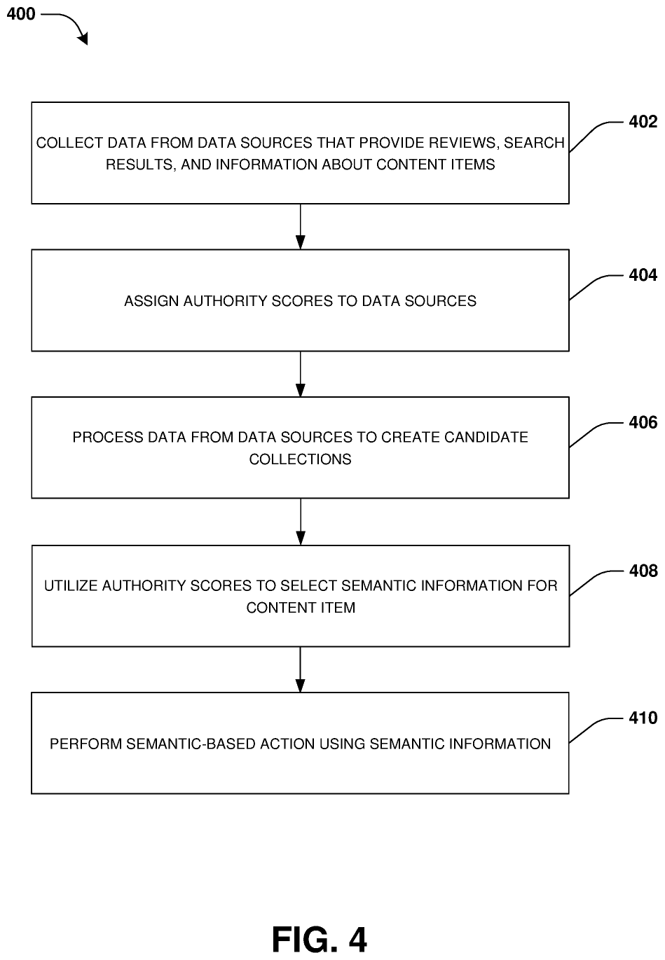

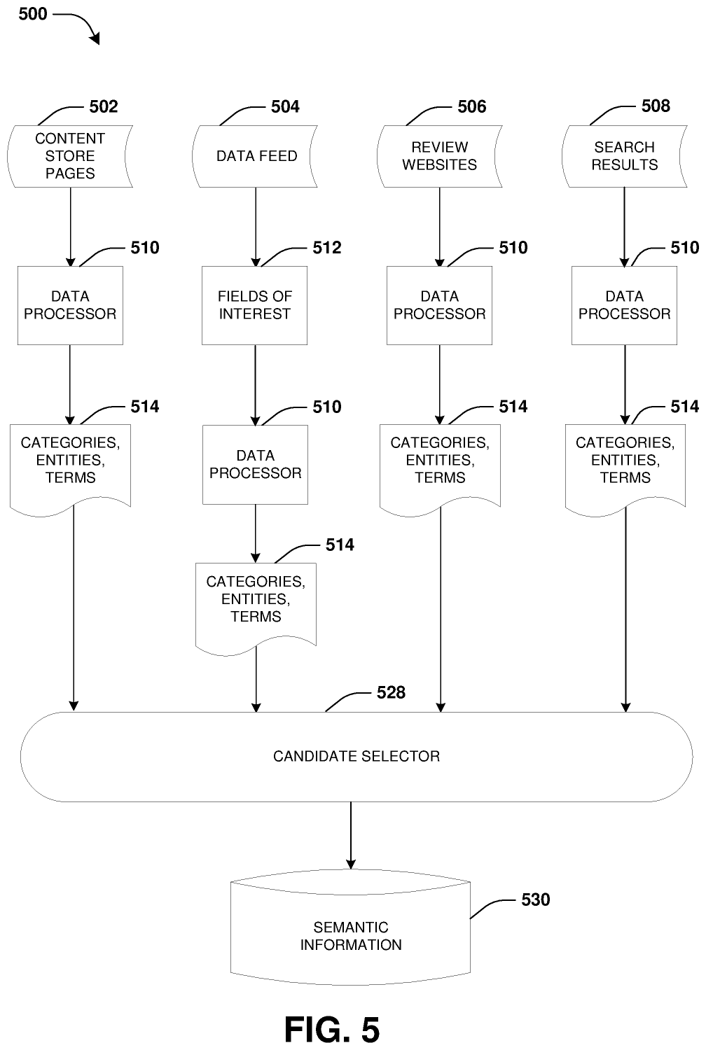

One embodiment of identifying and utilizing semantic information for content items is illustrated by an exemplary method 400 of FIG. 4 and is further described in conjunction with system 500 of FIG. 5. The method 400 may be executed by a computer implemented pipeline that includes various processes and components, such as data processors, a candidate selector, a filter component, a ranker component, a weighting component, and/or other hardware or software implemented functionality for identifying semantic information that can be used to perform various semantic-based actions (computer implemented functions).

The method 400 may utilize multiple data sources of information about content items in order to generate semantic information for the content items. In some embodiments, the content items may relate to applications (e.g., mobile apps available through an app store for download, and which may be described through app pages of the app store), multimedia content (e.g., music, movies, and videos available through various streaming services, applications, websites, or other content provider services), videogames (e.g., games available to download through a game service), product items (e.g., clothing, consumer goods, or other products or services available for purchase such as through a shopping website, a shopping app, etc.), etc. In some embodiments, the data sources provide information about content items, such as user reviews, professional reviews, titles, descriptions, categories, search results and summaries for queries submitted to search engines regarding the content items, etc. Data from these data sources is processed in order to identify relevant/useful semantic information for the content items so that semantic-based actions can be performed based upon the semantic information.

In some embodiments, the content sources comprise content store pages 502 (e.g., app store pages of mobile apps available for download from an app store, which may include descriptions, titles, categories, user reviews, etc.), a data feed 504 (e.g., a mobile apps data feed relating to statistics of users interacting with mobile apps on computing devices such as smart phones, smart watches, tablets, laptops, or other devices capable of executing mobile apps), review websites 506 (e.g., an electronics website that provides reviews for electronic product items, mobile apps, multimedia content, and/or other content items), and search results 508 (e.g., search results and summaries returned by a search engine for a query having keywords relating to a name of an app, a mobile platform supporting the app, a “ratings” keyword, a “reviews” keyword, and/or other keywords that could lead to search results having semantic information for a content item), as illustrated by FIG. 5. In this way, the data sources may provide reviews, search results, access to content items, and/or other information about content items available through and/or described by the data sources.

Instances of a data processor 510 are configured to collect data from the data sources such as the content store pages 502, the data feed 504, the review websites 506, and the search results 508, during operation 402 of method 400. In some embodiments, the data collected from the content store pages may include titles, user reviews, descriptions of applications available through a content store, etc. In some embodiments, the content store pages 502 may correspond to new content store pages of content items for which semantic information has not been generated and stored within a semantic information data store 530. For example, the data processor 510 may be configured to collect data relating to new content items not yet processed by the pipeline for creating semantic information. In some embodiments, the data processor 510 collects reviews from the review websites 506 for the new content items not yet processed by the pipeline for creating semantic information. In some embodiments, the data processor 510 constructs a query that includes keywords relating to a content item (e.g., a mobile platform name that supports an application, a name of the application, a “ratings” keyword, a “reviews” keyword, etc.). The data processor 510 submits the query to a search engine in order to obtain search results 508 and summaries returned by the search engine for the query submitted by the data processor 510. In this way, data is collected from the data sources by the data processor 510.

In some embodiments, the data processor 510 performs additional processing on the data collected from the data sources, such as the data feed 504. For example, fields of interest 512 are identified from the data feed 504 (a mobile app data feed). A field of interest may correspond to a title, a main category, a description, meta keywords, user views, or related information for a content item. The fields of interest 512 may be identified using field-specific markup language xpaths, a layout based machine learning model, or structure information. In this way, the fields of interest 512 are identified from the data feed 504.

During operation 404 of method 400, authority scores are assigned to the data sources based upon authoritativeness of the data sources. The authoritativeness of a data source may be based upon a data source type (e.g., a content store page, a user review, a field of interest from a mobile app data feed, a professional review from a review website, a search result, etc.), a domain quality (e.g., a quality of a domain of a review website), comprehensiveness of information extracted from a data source (e.g., whether a user review is sparse, fragmented, short, has poor grammar or spelling mistakes), etc.

During operation 406 of method 400, the data processor 510 processes the data from the content store pages 502 (e.g., an app store page describing a mobile app available from a mobile app store), the fields of interest 512 from the data feed 504 (e.g., a title, a main category, a description, meta keywords, user reviews, or related information for a content item), data from the review websites 506 (e.g., a webpage article reviewing a mobile app), data from the search results 508 (e.g., search query results and summaries for a search query), and/or data from other data sources in order to create candidate collections 514. A candidate collection for a content item comprises a set of semantic information for the content item from a particular data source, which may include categories (e.g., an art category for a sketching app), entities (e.g., non-ambiguous canonical forms of people, places, and/or other mentions/phrases such as George Washington, San Francisco, etc.), and terms (e.g., phrases, keywords, etc.) extracted from a data source. In some embodiments, a candidate collection is specific to a particular data source, and thus includes categories, entities, and terms extracted from that data source for a particular content item.

In some embodiments, each data source is individually processed to create the candidate collections 514. In some embodiments, combinations of the data sources are processed to create the candidate collections 514 (e.g., a candidate collection represents categories, entities, and terms derived using data from multiple content sources, or candidate collections from different content sources may be processed in combination to identify semantic information).

In some embodiments, a candidate collection comprises a bag of semantic information candidates such as categories, entities, and terms. In some embodiments of creating the candidate collections 514, a text processor is executed to process the data from each data source, thus resulting in source specific bags of semantic information candidates as the candidate collections 514. Depending on the source type, different techniques may be used to generate the source specific bags of semantic information candidates, such as text processing, a deep learning model, N-grams, and/or a text analysis platform. For example, a text analysis platform or custom tailored machine learning modules may be used in order to identify main categories, entities, and relevant terms. N-grams and corresponding Term Frequency-Inverse Document Frequency (TF-IDF) scores corresponding to the frequency of words are used to determine how relevant those words are to given data, which are used to select relevant terms from the data of the data sources. The terms can be selected based upon mentions of the terms across multiple fields of interest and/or data sources. For example, intersecting terms from an application description and from user reviews can be selected as semantic information candidates.

The candidate collections 514 are input into a candidate selector 528 configured to utilize various processing and the authority scores to select semantic information for a content item and to store the semantic information, in association with the content item, into the semantic information data store 530, during operation 408 of method 400.

In some embodiments, filtering is performed by the candidate selector 528 for each candidate collection. A candidate collection is filtered to remove blacklisted entries such as offensive or sensitive entries from the candidate collection.

Each candidate collection is ranked by the candidate selector 528 to create ranked candidate collections assigned ranks based upon relevancy, frequency, and/or uniqueness of semantic information within the candidate collections. If a candidate collection includes categories, entities, and/or terms that are determined to be relevant to a content item, occur frequently, and/or are unique (not redundant), then the candidate collection may be ranked relatively high. A subset of the ranked candidate collections may be selected based upon the ranks (e.g., highest ranked candidate collections may be selected). In this way, the subset of the ranked candidate collections are used to select semantic information for a content item. In some embodiments, the candidate selector 528 creates weighted combinations of categories, entities, and terms using the subset of ranked candidate collections and the authority scores in order to select semantic information to associate with a content item for inclusion within the semantic information data store 530. Weights for each candidate collection may be manually assigned or learned using a machine learning model, and a weighted combination is created using weights of the candidate collections. The weighted combinations are used to select the semantic information for inclusion within the semantic information data store 530 (e.g., semantic information with the highest weighted combinations may be selected).

During operation 410 of method 400, semantic information within the semantic information data store 530 is used to perform various semantic-based actions. In some embodiments, the semantic-based actions may include the tagging of a content item with relevant semantic information from the semantic information data store 530 so that the semantic information is available for users to access. In some embodiments, the semantic-based actions may include modifying the operation of an application based upon relevant semantic information from the semantic information data store 530 in order to provide a user with a personalized experience while interacting with the application.

In some embodiments, the semantic-based actions may include selecting a content item from available content items based upon the content item corresponding to semantic information within the semantic information data store 530, and providing or recommending the content item to a user. In some embodiments, the semantic-based actions may include generating content (a content item) based upon the semantic information from the semantic information data store 530 and based upon interests of a user, and providing or recommending the content to a user. In some embodiments, the semantic-based actions may include training a model (a machine learning model) using the semantic information from the semantic information data store 530. The model may be trained to identify content items that may be relevant to users, and thus the model can be used to select and provide or recommend content to a user that may be interested in the content. Content and/or a recommendation of content may be displayed to the user through a display of a device. In some embodiments, the semantic-based actions may include identifying an application that is similar to one or more applications utilized by a user, which may be identified based upon semantic information within the semantic information data store 530. A recommendation of the application may be provided to the user. In this way, various semantic-related actions may be executed in an automated manner, and may be performed in real-time (e.g., as new content items become available to process for identifying new semantic information that can be used to perform the semantic-related actions).

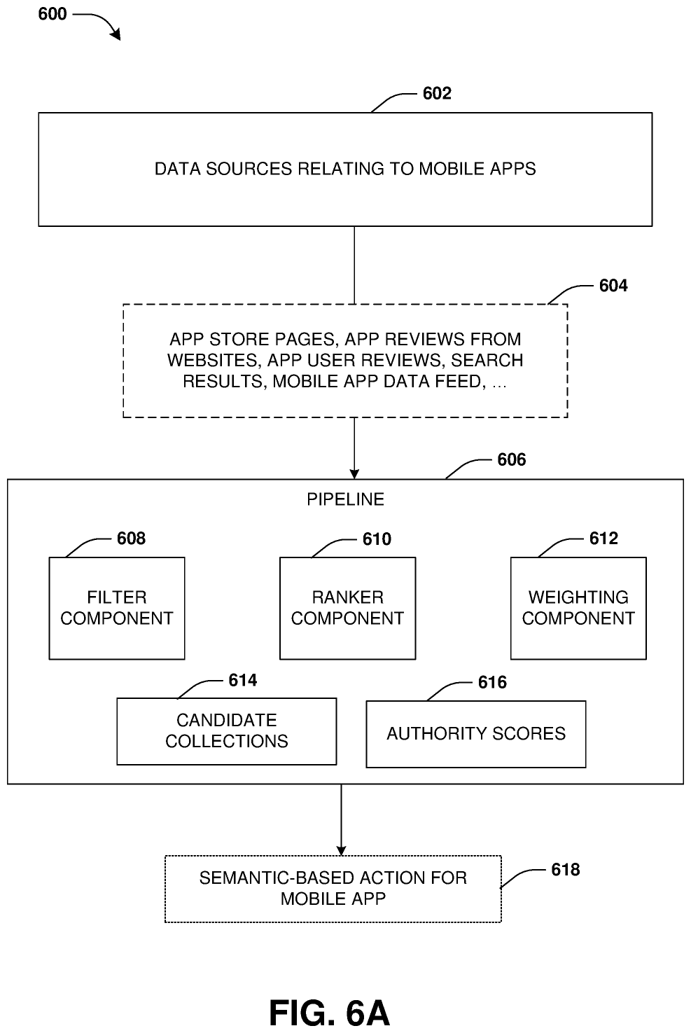

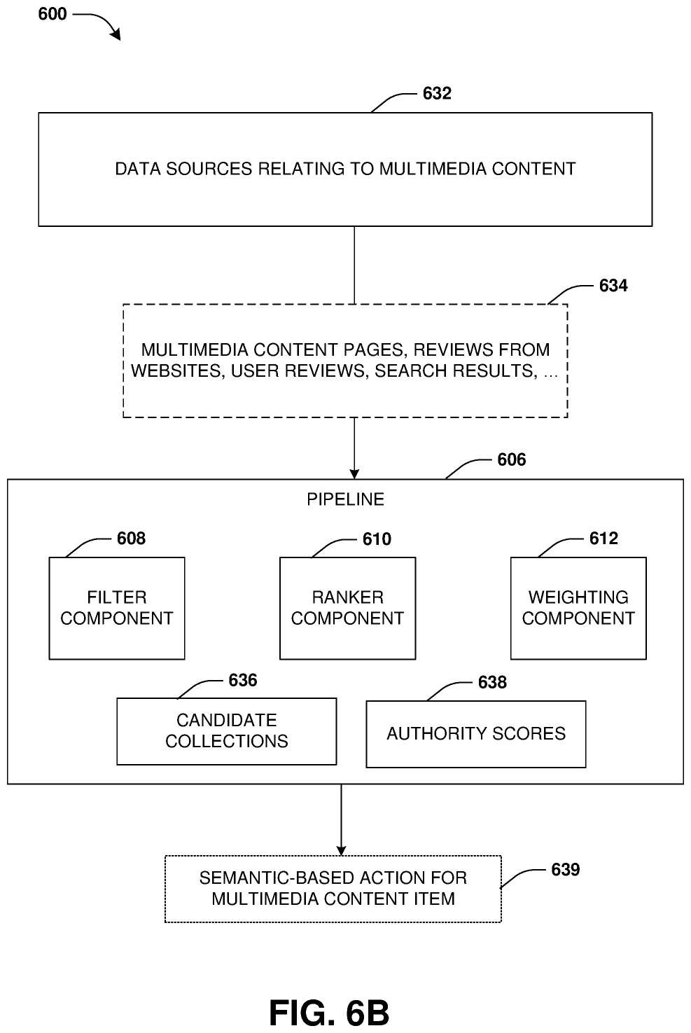

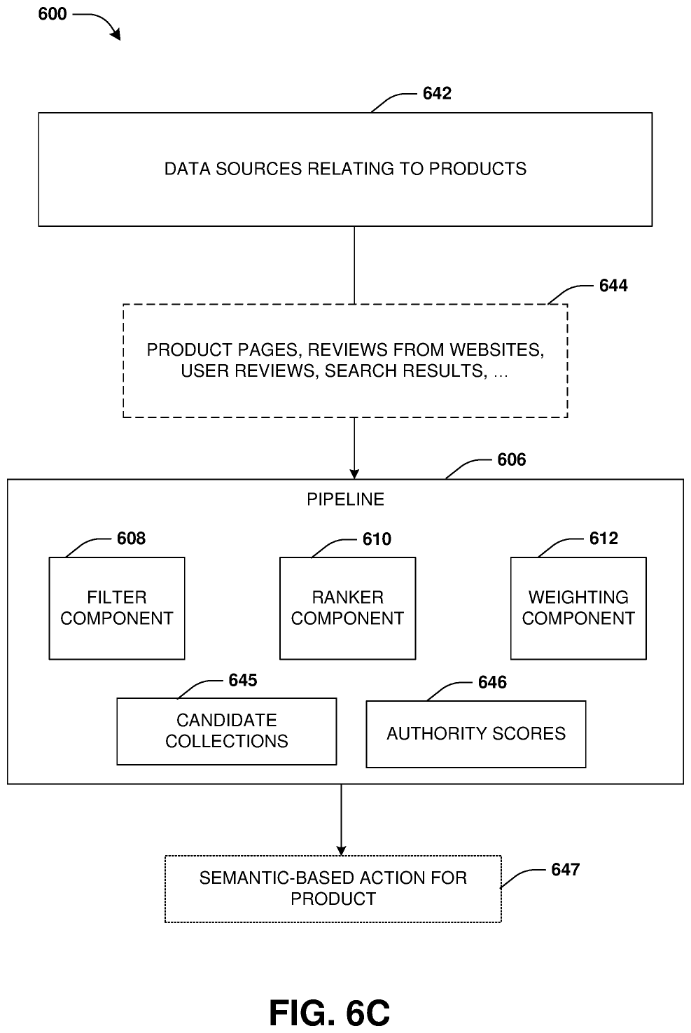

FIGS. 6A-6C illustrate a system 600 that includes a pipeline 606 configured for identifying and utilizing semantic information for content items. The pipeline 606 includes a filter component 608, a ranker component 610, a weighting component 612, and/or other components that may be implemented by a candidate selector (e.g., the candidate selector 528 of FIG. 5) and/or a data processor (e.g., the data processor 510 of FIG. 5), as illustrated by FIG. 6A. The pipeline 606 may access data sources 602 related to mobile applications (apps). The data sources 602 may include app store pages of an app store for the mobile applications, mobile application reviews from review websites, search results from a search engine in response to a search query about mobile application reviews and ratings for a particular mobile platform, a mobile application data feed, and/or other data sources. The pipeline 606 extracts data 604 from the data sources 602.

The pipeline 606, such as the data processor, processes the data 604 from the data sources 602 relating to the mobile applications to create candidate collections 614 corresponding to categories, entities, and/or terms extracted from the data 604 retrieved from the data sources 602. The categories, entities, and/or terms may relate to semantic information about a mobile application. The pipeline 606 may also evaluate the data sources 602 relating to the mobile applications in order to assign authority scores 616 to the data sources 602.

The pipeline 606 may perform various processing upon the candidate collections 614 of semantic information regarding the mobile applications. The pipeline 606 may execute the filter component 608 to filter blacklisted categories, entities, and/or terms from the candidate collections 614 of semantic information regarding the mobile applications. The pipeline 606 may execute the ranker component 610 to rank the candidate collections 614 of semantic information regarding the mobile applications based upon relevancy, frequency, and/or uniqueness of the semantic information within the candidate collections 614. The pipeline 606 may execute the weighting component 612 to create weighted combinations of categories, entities, and/or terms using a subset of the ranked candidate collections 614 (e.g., a set of highest ranked candidate collections).

The pipeline 606 uses the processed candidate collections 614 and the authority scores 616 to select semantic information for a mobile application. The semantic information for the mobile application may be used by the pipeline 606 to perform a semantic-based action 618 for the mobile application. The semantic-based action 618 may be performed to provide a user with a personalized experience for the mobile application or for a similar mobile application. The semantic-based action 618 may be performed to generate and provide a recommendation of content to the user. The semantic-based action 618 may be performed to select and provide content that may be of interest to the user. The semantic-based action 618 may be performed to train a machine learning model to more accurately predict/identify interests of a user of the application and/or to predict/identify attributes of the user such as age and gender.

Referring to FIG. 6B, the pipeline 606 may access data sources 632 related to multimedia content (e.g., movies, music, videogames, videos, audiobooks, electronic books, etc.). The data sources 632 may include multimedia content pages of a multimedia content store for the multimedia content, multimedia content reviews from review websites, search results from a search engine in response to a search query about multimedia content reviews and ratings, and/or other data sources. The pipeline 606 extracts data 634 from the data sources 632.

The pipeline 606, such as the data processor, processes the data 634 from the data sources 632 relating to the multimedia content to create candidate collections 636 correspond to categories, entities, and/or terms extracted from the data 634 retrieved from the data sources 632. The categories, entities, and/or terms may relate to semantic information about multimedia content such as a movie available to watch from a movie streaming service. The pipeline 606 may also evaluate the data sources 632 relating to the multimedia content in order to assign authority scores 638 to the data sources 632.

The pipeline 606 may perform various processing upon the candidate collections 636 of semantic information regarding the multimedia content. The pipeline 606 may execute the filter component 608 to filter blacklisted categories, entities, and/or terms from the candidate collections 636 of semantic information regarding the multimedia content. The pipeline 606 may execute the ranker component 610 to rank the candidate collections 636 of semantic information regarding the multimedia content based upon relevancy, frequency, and/or uniqueness of the semantic information within the candidate collections 636. The pipeline 606 may execute the weighting component 612 to create weighted combinations of categories, entities, and/or terms using a subset of the ranked candidate collections 636 (e.g., highest ranked candidate collections).

The pipeline 606 uses the processed candidate collections 636 and the authority scores 638 to select semantic information for the multimedia content. The semantic information for the multimedia content may be used by the pipeline 606 to perform a semantic-based action 639 for the multimedia content. The semantic-based action 639 may be performed to provide a user with a personalized experience for the multimedia content or for similar multimedia content. The semantic-based action 639 may be performed to generate and provide a recommendation of content to the user. The semantic-based action 639 may be performed to select and provide content that may be of interest to the user. The semantic-based action 639 may be performed to train a machine learning model to more accurately predict/identify interests and attributes of users that interacted with the multimedia content and/or to identify and recommend a similar multimedia content to the user.

Referring to FIG. 6C, the pipeline 606 may access data sources 642 related to products (e.g., clothes, electronics, services, consumer goods, etc.). The data sources 642 may include products pages of a product store for the products (e.g., a shopping website or shopping app), product reviews from review websites, search results from a search engine in response to a search query about a particular product and reviews and ratings for the product, and/or other data sources. The pipeline 606 extracts data 644 from the data sources 642.

The pipeline 606, such as the data processor, processes the data 644 from the data sources 642 relating to the products in order to create candidate collections 645 corresponding to categories, entities, and/or terms extracted from the data 644 retrieved from the data sources 642. The categories, entities, and/or terms may relate to semantic information about products such as a lawn mower for purchase. The pipeline 606 may also evaluate the data sources 642 relating to the products in order to assign authority scores 646 to the data sources 642.

The pipeline 606 may perform various processing upon the candidate collections 645 of semantic information regarding the products. The pipeline 606 may execute the filter component 608 to filter blacklisted categories, entities, and/or terms from the candidate collections 645 of semantic information regarding the products. The pipeline 606 may execute the ranker component 610 to rank the candidate collections 645 of semantic information regarding the products based upon relevancy, frequency, and/or uniqueness of the semantic information within the candidate collections 645. The pipeline 606 may execute the weighting component 612 to create weighted combinations of categories, entities, and/or terms using a subset of the ranked candidate collections 645 (e.g., highest ranked candidate collections).

The pipeline 606 uses the processed candidate collections 645 and the authority scores 646 to select semantic information for the products. The semantic information for the multimedia content may be used by the pipeline 606 to perform a semantic-based action 647 for the products. The semantic-based action 647 may be performed to generate and provide a recommendation of a similar product to the user. The semantic-based action 647 may be performed to train machine learning model to more accurately identify interests of users that view or purchase the product.

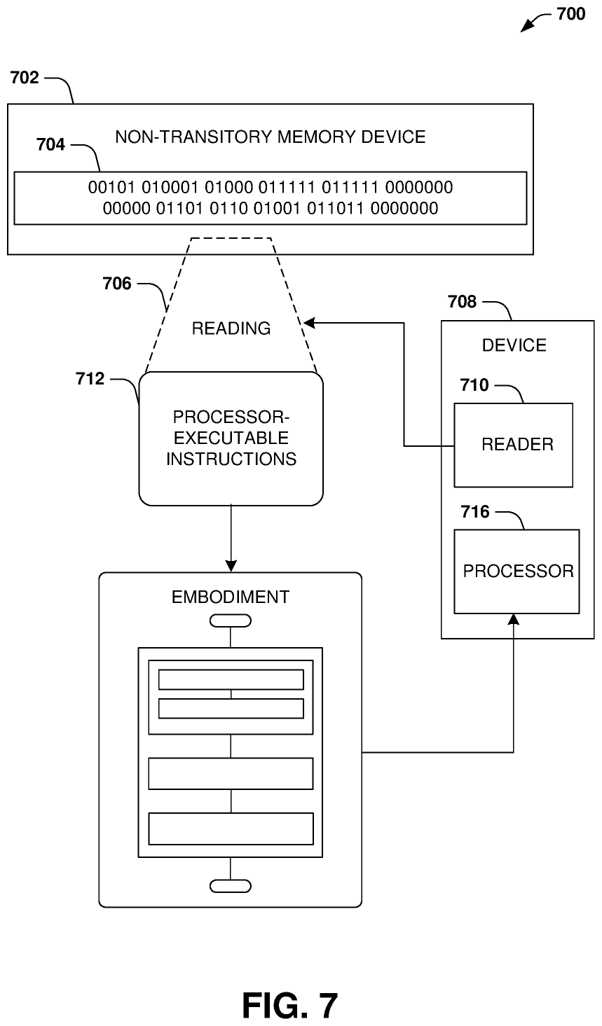

FIG. 7 is an illustration of a scenario 700 involving an example non-transitory machine readable medium 702. The non-transitory machine readable medium 702 may comprise processor-executable instructions 712 that when executed by a processor 716 cause performance (e.g., by the processor 716) of at least some of the provisions herein. The non-transitory machine readable medium 702 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 702 stores computer-readable data 704 that, when subjected to reading 706 by a reader 710 of a device 708 (e.g., a read head of a hard disk drive, or a read operation invoked on a solid-state storage device), express the processor-executable instructions 712. In some embodiments, the processor-executable instructions 712, when executed cause performance of operations, such as at least some of the example method 400 of FIG. 4, for example. In some embodiments, the processor-executable instructions 712 are configured to cause implementation of a system, such as at least some of the example system 500 of FIG. 5 and/or at least some of the example system 600 of FIGS. 6A-6C, for example.

### 3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In some embodiments, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method executing on a processor of a computing device that causes the computing device to perform operations comprising:
collecting data from data sources that provide information about content items;
assigning authority scores to the data sources based upon authoritativeness of the data sources;
processing the data from the data sources to create candidate collections, wherein a candidate collection for a content item comprises a set of semantic information corresponding to at least one of a category, an entity, or a term extracted from a data source;
utilizing the authority scores to select semantic information for the content item from the candidate collections; and
performing a semantic-based action using the semantic information.

2. The method of claim 1, wherein the performing the semantic-based action comprises:
modifying operation of an application based upon the semantic information, wherein the operation is modified to provide a user with a personalized experience while interacting with the application.

3. The method of claim 1, wherein the performing the semantic-based action comprises:
selecting content from available content to provide to a user based upon the content corresponding to the semantic information; and
displaying the content to the user through a display of a device.

4. The method of claim 1, wherein the performing the semantic-based action comprises:
generating content based upon the semantic information, wherein the content is tailored to an interest of a user; and
displaying the content to the user through a display of a device.

5. The method of claim 1, wherein the performing the semantic-based action comprises:
training a model using the semantic information;
utilizing the model to select content from available content to provide to a user; and
recommending the content to the user.

6. The method of claim 1, wherein the performing the semantic-based action comprises:
identifying an application that is similar to one or more applications utilized by a user, wherein the application is identified as being similar to the one or more applications based upon the semantic information; and
providing a recommendation of the application to the user.

7. The method of claim 1, wherein the assigning the authority scores comprises:
determining authoritativeness for the data source based upon a data source type, a domain quality, and information comprehensiveness of information extracted from the data source.

8. The method of claim 1, wherein the data source comprises a mobile app data feed of a mobile app, and wherein the method comprises:
identifying fields of interest from the mobile app data feed, wherein the fields of interest correspond to at least one of a title, a main category, a description, meta keywords, user reviews, or related applications for the mobile app, wherein the fields of interest are identified using at least one of field-specific markup language xpaths, a layout based machine learning model, or structural information; and
processing the fields of interest to create the candidate collection.

9. The method of claim 1, comprising:
filtering, from the candidate collections, blacklisted entries.

10. The method of claim 1, comprising:
assigning ranks to the candidate collections to create ranked candidate collections based upon at least one of relevancy, frequency, or uniqueness of semantic information within the candidate collections;
selecting a subset of the ranked candidate collections based upon the ranks; and
selecting the semantic information for the content item using the subset of the ranked candidate collections.

11. The method of claim 10, comprising:
creating weighted combinations of categories, entities, and terms using the subset of the ranked candidate collections and the authority scores; and
selecting the semantic information for the content item using the weighted combinations.

12. The method of claim 1, wherein the performing the semantic-based action comprises:
tagging an application with the semantic information.

13. A non-transitory machine readable medium having stored thereon processor-executable instructions that when executed cause performance of operations, the operations comprising:
collecting data from data sources that provide at least one of reviews, search results, access to, or information about content items;
assigning authority scores to the data sources based upon authoritativeness of the data sources;
processing the data from the data sources to create candidate collections, wherein a candidate collection for a content item comprises a set of semantic information corresponding to at least one of a category, an entity, or a term extracted from a data source;
utilizing the authority scores to select semantic information for the content item from the candidate collections; and
tagging the content item with the semantic information.

14. The non-transitory machine readable medium of claim 13, wherein the collecting comprises:
collecting the data from app store pages of an app store, wherein the data comprises titles, reviews, and descriptions of applications available from the app store pages, and wherein the content items comprise the applications.

15. The non-transitory machine readable medium of claim 13, wherein the collecting comprises:
collecting the data from content item review websites, and wherein the content items comprise at least one of applications, movies, music, videogames, videos, or shopping products.

16. The non-transitory machine readable medium of claim 13, wherein the collecting comprises:
generating a query that includes a mobile platform and keywords relating to at least one of ratings and reviews;
submitting the query to a search engine to obtain search results and summaries; and
extracting the data from the search results and the summaries.

17. A computing device comprising:
a processor; and
memory comprising processor-executable instructions that when executed by the processor cause performance of operations, the operations comprising:
collecting data from data sources that provide at least one of reviews, search results, access to, or information about content items;
assigning authority scores to the data sources based upon authoritativeness of the data sources;
processing the data from the data sources to create candidate collections, wherein a candidate collection for a content item comprises a set of semantic information from a data source;
utilizing the authority scores to select semantic information for the content item from the candidate collections; and
tagging the content item with the semantic information.

18. The computing device of claim 17, wherein the operations comprise:
processing the data from the data sources utilizing at least one of text processing, a deep learning model, N-grams, or a text analysis platform.

19. The computing device of claim 17, wherein the operations comprise:
individually processing each data source to create the candidate collections.

20. The computing device of claim 17, wherein the operations comprise:
processing combinations of the data sources to create the candidate collections.
